(19) United States
(12) Patent Application Publication
(10) Pub. No.: US 2017/0028382 A1
(43) Pub. Date: Feb. 2, 2017

(54) Oxygen Absorber

(71) Applicant: Multisorb Technologies, Inc., Buffalo, NY (US)

(72) Inventor: Eileen A. Stetter, Hamburg, NY (US)

(21) Appl. No.: 15/301,305

(22) PCT Filed: Mar. 31, 2014
(86) PCT No.: PCT/US14/32402

§ 371 Date: Sep. 30, 2016

(51) Int. Cl. B01J 20/28; B65D 81/18; B29C 65/38; B29C 65/00; B05D 1/26; B29C 65/08

(52) U.S. Cl. CPC B01J 20/2805; B05D 1/265; B29C 65/08; B29C 65/38; B29C 66/1142; B65D 81/18; B29K 2623/0633

(57) ABSTRACT

An oxygen scavenger includes a coated film formed as a sachet and an oxygen scavenger retained in the sachet. The coated film may include a spun-bonded polyolefin base layer coated with a USP-grade low density polyethylene. The resulting sachet is non-porous with a tunable permeability.

### BACKGROUND OF THE INVENTION

Field of the Invention

This disclosure relates generally to oxygen absorbers and more particularly to oxygen absorbers in the form of packets, sometimes referred to as sachets made at least in part from extrusion coated, oxygen permeable spun-bonded, polyolefin or other spun bonded polymeric material enclosing an oxygen absorbing powder or capsule.

Description of Related Art

Oxygen absorbers have existed in a variety of forms for many years. Among the popular types of packaging for oxygen absorbers are canisters, packets and sachets. All three types of oxygen absorber packaging have been widely used with great success.

One very widely used and popular absorber is packaged in a three layer coated paper packet, sometimes referred to herein as a sachet that while satisfactory in most regards, is sometimes difficult to seal. The packet is formed from a grease resistant paper substrate, a microperforated polyester film on one side of the paper substrate that provides tear resistance and structural strength, and a sealing layer made from ethylene vinyl acetate or polyethylene on the other side of the substrate. This construction is difficult or impossible to seal ultrasonically, a desirable technique for high speed automated manufacture. While the sealing layer of this construction is not perforated, it cannot be readily varied in thickness or permeability because its primary function and characteristics are selected to form a seal.

As oxygen absorbers become even more widely used, there is a need for increasingly lower cost absorbers that retain or enhance the performance of absorbers already in existence. While both canisters and sachets provide good performance at reasonable cost, sachets are generally less expensive to manufacture than canisters and are useful in many applications. However, current sachets often are made from materials such as laminated greaseproof film that was micro perforated to facilitate the transmission of oxygen that can make it difficult to form the sachet itself by making it more problematic to seal the material to itself in high speed packaging operations. Uncoated spun bonded polyolefin does not provide a convenient way to tailor the characteristics of an absorber made from it. It is highly porous, it does not provide a way to adjust its oxygen and water vapor permeability for specific applications, and there is no convenient way to tailor the porosity, which often results in undesirable dusting of fine particulates through it. Therefore, it is desired to have a film that has the desired characteristics of high oxygen and low water vapor transmission rates, can provide tailorable performance, is easily sealable to itself via conventional sealing techniques, and is also easy to process.

### BRIEF SUMMARY OF THE INVENTION

Briefly stated and in accordance with one aspect of this disclosure, an oxygen absorber includes an oxygen absorbing composition in the form of a powder or capsule or other similar form and a package in the form of a sachet in which the oxygen absorbing composition is contained. The sachets are formed from a coated sheet material having a porous base layer, preferably a fibrous polymeric material such as a woven or non-woven polyester or spun bonded, polymeric such as polyolefin formed, for example from high density polyethylene, and a continuous, permeable to oxygen, polyethylene coating layer, preferably formed from low-density polyethylene. The coated sheet material can be formed into a packet or sachet of any traditional shape or width, though the preferred sachet format as at least one seal formed between opposing edges of the sheet material with the low-density polyethylene coating layer of one edge bonded to the low-density polyethylene coating layer of the opposing edge, or the low-density polyethylene coating layer of one edge bonded to the high-density spun-bonded polyolefin layer of the opposing edge. The oxygen absorber, which may be in the form of loose powder or a tablet or capsule, is contained within the sachet.

### BRIEF DESCRIPTION OF THE SEVERAL VIEWS OF THE DRAWING(S)

FIG. 1 is a diagrammatic side view of a portion of a strip of oxygen absorbers in accordance with one aspect of this disclosure.

FIG. 2 is a diagrammatic view of the reverse side of the strip of oxygen absorbers in FIG. 1.

FIG. 3 is a section taken along lines 3-3 of FIG. 2.

FIG. 4 is a graph showing “wet” test results for a 60% water activity oxygen absorber in sachets made of laminated grease proof film and sachets made according to embodiments of this disclosure.

FIG. 5 is a graph showing “dry” test results for a 60% water activity oxygen absorber in sachets made of laminated grease proof film and sachets made according to embodiments of this disclosure.

FIG. 6 is a graph showing “wet” and “dry” test results for a 42% water activity oxygen absorber in sachets made of laminated grease proof film and sachets made according to embodiments of this disclosure.

FIG. 7 is a graph showing “dry” test results for a 60% water activity oxygen absorber in sachets made of greaseproof film, Tyvek, and sachets made according to embodiments of this disclosure.

FIG. 8 is a graph showing “wet” and “dry” test results of a 60% water activity oxygen absorber in sachets made of laminated greaseproof film and sachets made according to embodiments of this disclosure.

### DETAILED DESCRIPTION OF THE INVENTION

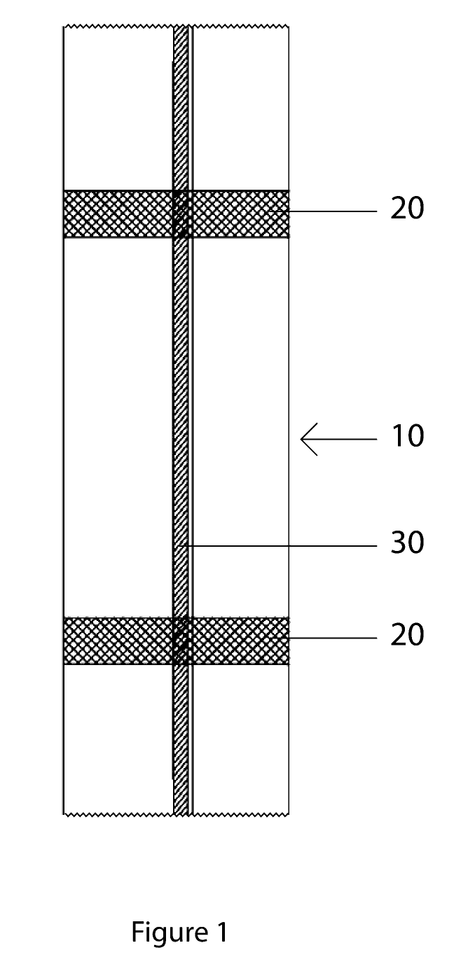

FIGS. 1-3 illustrate a strip of oxygen absorbers 10 in accordance with one embodiment of this disclosure. Each absorber 10 is in the form of a packet or sachet that encloses a quantity of oxygen absorbing material 60. The material 60 which may be a material that absorbs oxygen in the presence of moisture may be in the form of a powder, a slurry, a tablet or other solid form. In some embodiments, the oxygen absorbing material may include powdered iron, a material that combines with moisture to form an electrolyte, and a material for providing moisture, either by absorbing moisture from the atmosphere, releasing moisture previously introduced into the material, or a combination of both. Additionally, the material need not be oxygen absorbing in nature. A moisture supplying material, such as a humectant, hydrated silica gel, or other such material, would benefit from the disclosed invention. Therefore, while examples below are described in the context of oxygen absorbers, a person of ordinary skill would comprehend other such materials that would benefit from the moisture transmission management and/or tuning afforded by aspects of this disclosure.

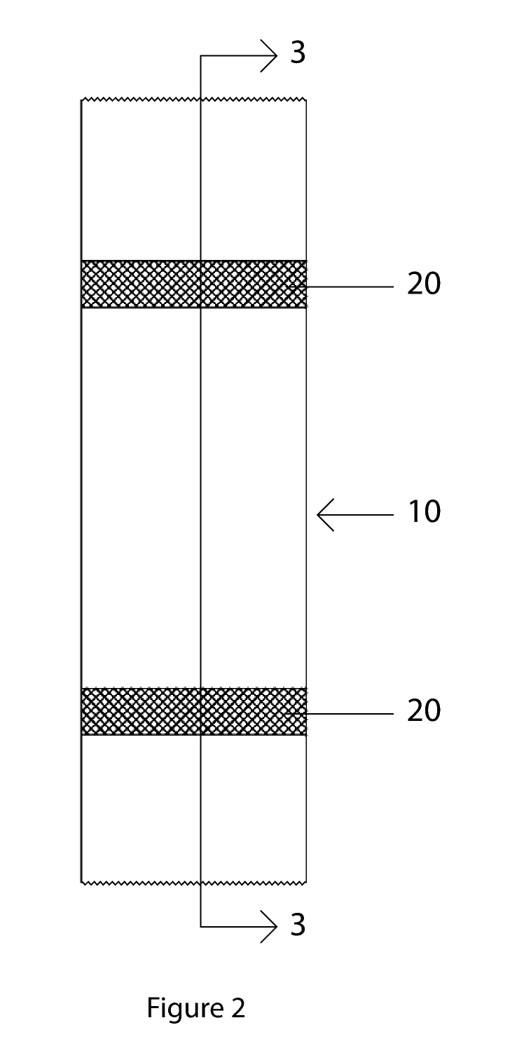

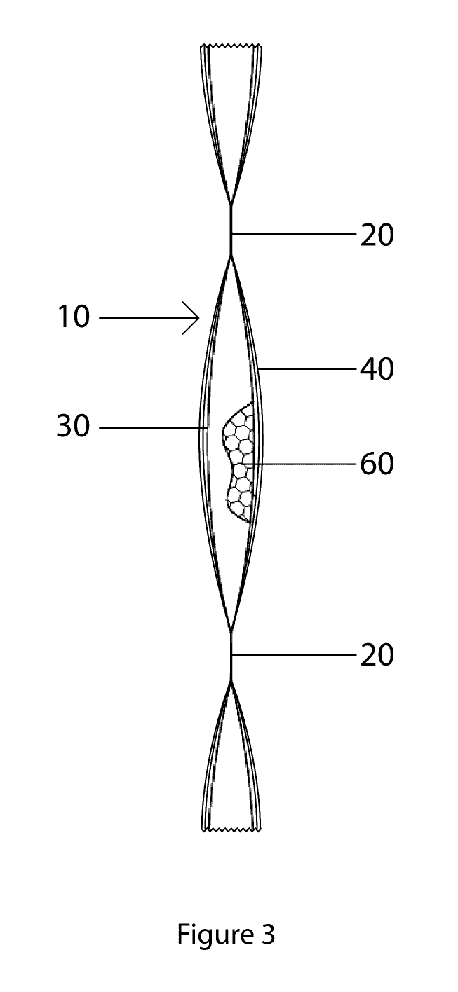

The oxygen absorber of FIGS. 1 and 2 is shown in a cross-sectional view in FIG. 3. As can be seen by referring to FIGS. 1, 2, and 3, the absorber is in the form of a packet or sachet that envelops the oxygen absorbing material 60.

The packet or sachet is formed from a sheet of material the composition of which is shown in FIG. 3. The sheet includes a porous base layer 40, which may be formed from a nonwoven spun bonded high density polyolefin material. Spun bonded material sold under the Tyvek trademark by E. I. du Pont de Nemours is an example of a material that can be used as the base layer 40.

A substantially continuous, oxygen permeable coating layer 50 is extrusion coated onto the porous base layer 40. Low-density polyethylene (LDPE) or another related polymer or copolymer may be used for the coating layer. LDPE has selected high oxygen permeability properties and low moisture permeability. Using a material with these properties allows for any moisture that is present in the oxygen absorbing material 60 to remain in the sachet and react with the rest of the components of the oxygen absorber to promote the absorption of oxygen, while allowing moisture vapor to permeate through the material.

Preferably, the low-density polyethylene material 50 is extrusion coated onto the porous base layer 40. This is illustrated in the following examples. The low-density polyethylene coating material is preferably a continuous layer, substantially free of voids. It is, therefore, preferably permeable to oxygen, and less permeable or substantially impermeable to moisture, but not porous. Any significant presence of voids could decrease the effectiveness of the oxygen absorber 10 as a whole, since it could allow for rapid loss of moisture from the interior and reduce the overall efficacy of the oxygen absorber. Therefore it is important that methods used to increase the porosity, such as the use of air knives which is common in conventional Tyvek coating operations, are not used to ensure a uniform permeable coating layer without voids.

In some implementation, for example, when spun-bonded polyolefin is used as the base layer 40, the low density polyethylene 50 may encapsulate surface fibers of the base layer 40. More specifically, when the coating layer is applied as a melted polymer, the coating will flow to fill voids in the surface of the spun-bonded polyolefin between the strands comprising the polyolefin. Depending upon the contours and configurations of those voids, the melted coating may completely encapsulate some or all of the fibrous strands on the surface of the base layer, although it will maintain a continuousness that renders the coated surface of the base layer non-porous. Encapsulating some of the surface fibers provides a mechanical bond in addition to the heat-sealing of the coating to the surface of the base layer 40. As a result, the coating is tenaciously bonded to the surface and penetrates the base layer 40 to a sufficient extent that it is not readily separated even during use and accompanying mechanical abuse of the material. The coated base layer becomes, in effect, an essentially inseparable single layer. The flexibility, processability and other mechanical properties of the base layer 40 are otherwise largely unaffected by the coating layer 50. In addition, the sealing properties, especially the self-sealing properties, are improved significantly compared to the uncoated spun-bonded base material 40. Even with this encapsulation, however, the coating is still a continuous layer in that it renders the coated surface of the base layer substantially non-porous.

In some implementations, the coating layer 50 is a permeable, low-density polyethylene. Depending upon the intended use for the material, the coating layer 50 may be United States Pharmacopeia (USP) grade without any contaminants that are not acceptable for use in food or pharmaceutical packaging. The coating layer 50 may be from 0.25 to 1.5 mil thick. However, the thickness and permeability of the coating layer 50 as applied may be varied to change the performance characteristics of the oxygen absorber. The effective average coating thickness is affected by the roughness of the coated surface, the degree of the coating stretching during application, and the degree of encapsulation of the surface fibers by the coating layer. The minimum effective coating thickness to maintain a continuous coating layer in the disclose process is estimated to be at least 0.25 mil or more. The thinner and/or more permeable the layer, the more rapid the transmission of oxygen into the package and the more quickly the oxygen absorber within the packet will react with the oxygen. Sachets made from materials in which the thickness of the coating layer is below 0.5 mil, as applied, and below 0.25 mil is the effective average, perform similarly to sachets made from the uncoated base layer alone. Moreover, when relatively thinner coatings are used, it may be more difficult to avoid creating voids in the coating, possibly reducing the long-term effectiveness of the sachet. Thicknesses between 0.5 and 1.0 mil result in oxygen absorption performance that is slower than the performance of uncoated materials by a factor of up to about two. Thicknesses above 1.0 mil produce even slower performance, which may be desirable in some applications.

An additional benefit of filling the voids and encapsulating the individual fibers on the surface of the spun-bonded base layer 40 is to prevent any powdered material in the sachet from leaking out through the voids. This is more generally known as dusting. Dusting is a concern when the end-user does not want the material being protected contaminated by foreign matter. While this is a concern with oxygen absorbers, it may also be a concern with absorbers in general, especially desiccants. Dusting is believed to occur primarily when the size of the openings in the spun bonded high-density polyolefin material is not carefully controlled during manufacturing.

By adjusting the thickness of the coating layer 50, performance that matches the requirements of a particular application can be provided without significantly varying the composition of the oxygen absorber, or any other absorber, within the sachet. For example, an absorber with a thicker coating layer will absorb oxygen more slowly than an absorber with a thinner layer which may be useful when especially long life rather than the highest possible initial absorption is required.

As a result of the manufacturing process, many currently available spun-bonded polyolefins have a smooth side and a rough side.

In examples described below, a spun-bonded polyolefin having a rough side and a smooth side was used. The coating process started by treating the rough side of the nonwoven spun-bonded polyolefin with corona plasma at about 2.6 kilowatts applied along a 60 inch width. The corona treatment can be anywhere between 2-4 kilowatts for plasma generators of this length as that range will sufficiently modify the surface energy of the nonwoven spun-bonded polyolefin to allow for better adhesion, however 2.6 kW was sufficient for the given materials.

The treated spun-bonded polyolefin then proceeded through the coating process. More specifically, the treated nonwoven spun-bonded polyolefin was coated with a low-density polyethylene having a melt index of 7. The low-density polyethylene was extruded from a die at a temperature of about 580° F. and was deposited at a temperature of about 568° F. The depositing temperature preferably may range from about 482° F. to about 635° F. The polyethylene's melt index can also be in a range of about 4 to about 16. It was found that when the coating's melt index was below 4, there were issues with adhesion to the base layer and higher temperatures were required for processing. However, when the melt index was greater than 16 neck in at the die was experienced, which caused only partial coating of the base layer, i.e., leaving the edges uncoated. While any of these combinations will work it was found that for the given substrate the best adhesion and processing occurred at 580° F. and with a polymer with a melt index of 7.

The completed film was then put over a chill roll at a temperature of 55° F. and then wound, on a spool, for storage and further processing.

As an alternative, certain coatings can be applied through a solution coating process at ambient temperatures. Any generally accepted solution coating method can be used to achieve good results, such as slot-die, gravure, or flexographic. The current samples were created using industry standard slot-die coating methods.

A number of oxygen absorbing sample sachets was made using materials formed by the extrusion coating process and tested. Two types of non-woven, spun bonded polyolefin were used, both provided by DuPont, and with three types of L low-density polyethylene both provided by Chevron Phillips, and one type of high-density polyethylene provided by Dow, at two different coating thicknesses. Sachets coated with ethylene acrylic acid were formed through the solution coating process. A breakdown of these is shown in Table 1.

TABLE 1

| Grade | Name |
|---|---|
| 1059B (old) | Dupont Tyvek |
| 1059B (new) | Dupont Tyvek |
| 1007 | Chevron-Phillips LDPE MI = 7 |
| 4517 | Chevron-Phillips LDPE MI = 5 |
| 1412 | Chevron-Phillips LDPE MI = 32 |
| 8907 | Dow Chemical HDPE MI = 6.75 |
| 4983R | Michelman Michem Ethylene |
| | Acrylic Acid |

The sachets were made using a conventional vertical form-fill-seal machine, which forms a sachet by wrapping the film material around a mandrel and forming a bottom seal 20, for example, by ultrasonic welding. The machinery then forms a lap seal 30, for example, using impulse welding, fills the newly formed pocket with an iron-based oxygen absorbing composition and creates a top seal 20, which can be the bottom seal 20 of the next sachet, for example, by ultrasonic welding. Other methods of making sachets can also be used, such as a three-sided sachet with fin seals or lap seals, a vertical form-fill-seal with a fin seal, or any other suitable method. Additional methods of sealing the sachets, such as impulse, heat, or ultrasonic sealing, may also be used. We believe that the seal thus formed is a seal between opposing base layers without requiring the coating layer to act as a sealing layer. This allows a good seal to be made while at the same time allowing the coating layer to be varied in composition and thickness to produce the desired oxygen absorbing performance and moisture permeability.

Each sachet was placed in an oxygen barrier bag simulating either a wet environment or a dry environment. The bags simulating a wet environment contained absorbent paper having 1 mL of absorbed water and an oxygen absorbing sachet anchored to the inside of the bag to prevent the sachet from contacting the absorbent paper. The bags simulating a dry environment only contained the oxygen-absorbing sachet. Each of the barrier bags was filled with 1500 cc of standard compressed air. An additional dry control was created which comprised an empty barrier pouch of 1500 cc of air. Additional sachets were made of a laminated greaseproof film that was micro perforated to facilitate the transmission of oxygen, and placed into separate wet and dry barrier bags prepared as described above.

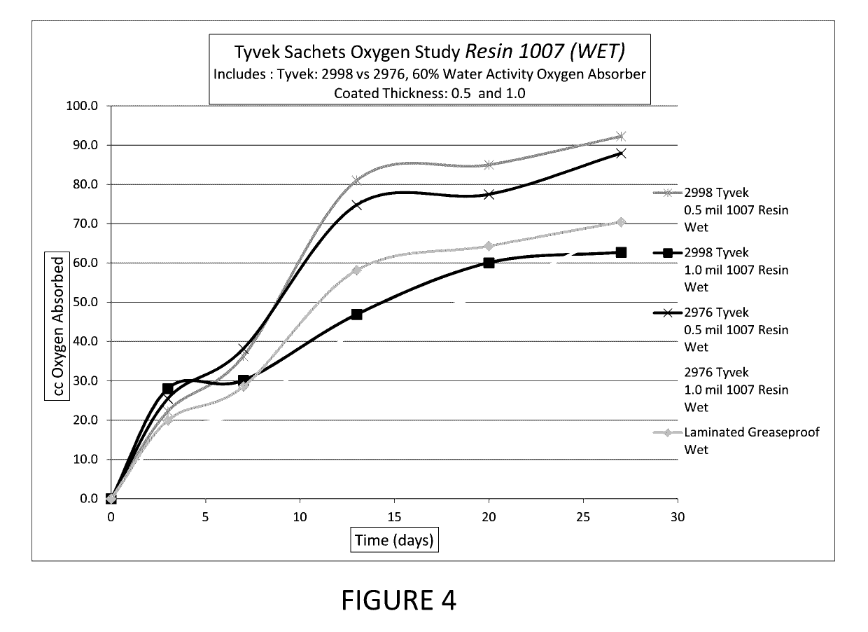

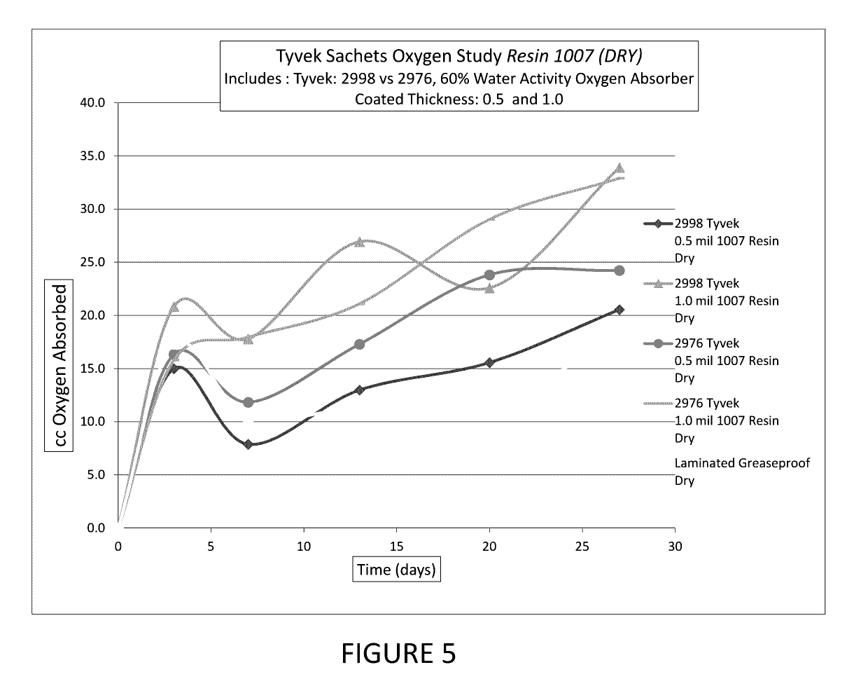

All the laminated greaseproof sachets were filled with the same oxygen absorbing composition as the coated sachets and subjected to the same testing conditions. Each of the bags was kept at ambient temperature, stored upright in a box, and the oxygen concentration of each bag was tested at 3, 7, 13, 20, 27, and 41 days from the start of the test. FIGS. 4 and 5 illustrate the results of these tests. Specifically, FIG. 4 shows the results of the wet tests while FIG. 5 shows results of the dry tests. While the results set forth below are believed to be accurate, it should be understood that this data fairly represents a comparison of the new material with existing materials under laboratory conditions, but may not exactly represent the expected performance of either the new material or the existing material under real-world conditions.

From FIG. 4 it is apparent that the film with the 0.5 mil coating absorbed oxygen significantly faster than the grease-proof laminated film and the 1.0 mil coated films. It is important to note however that one sample of the 1 mil coated film appeared to be about to overtake the perforated product in total amount of oxygen absorbed right at the end of the testing period.

FIG. 5 shows the results of testing in a dry environment where the oxygen absorbing composition must provide its own moisture to facilitate the reaction. Here all four coated samples outperformed the micro perforated film. As between the two coated films, the 1.0 mil samples outperformed the 0.5 mil samples in an initial speed of absorption. This would seem to indicate that the thicker coatings allow for the retention of more moisture that more than compensated for their expected lower permeability. However, as for overall rate of absorption, the thinner coats seem to perform more than adequately. After the oxygen testing reached completion, limited seal testing occurred on select samples, as shown in Table 2. The results show that even after use, the seals of the coated material require greater strength to be separated versus the greaseproof laminated seals.

TABLE 2

| | | | | Seal peel | | |
|---|---|---|---|---|---|---|
| | | | Oxygen | strength | | |
| | | | Absorption | (lb/in) - | | |
| Sample | | Coating | day 28 | avg. | | Ultrasonic |
| Description | Coating Type | thickness | (avg. cc) | filled | Heat Seal | seal (kHz) |
| Greaseproof | — | — | 41.4 | 4.74 | 250 F. | |
| Laminate | | | | | | |
| LDPE coated | Chevron | 1 mil | 44.4 | 5.94 | 250 F. | |
| 1059B tyvek | 1412 LDPE | | | | | |
| LDPE coated | Chevron | 1 mil | 44.9 | 5.99 | 250 F. | 95-100 |
| 1059B tyvek | 1007 LDPE | | | | | |

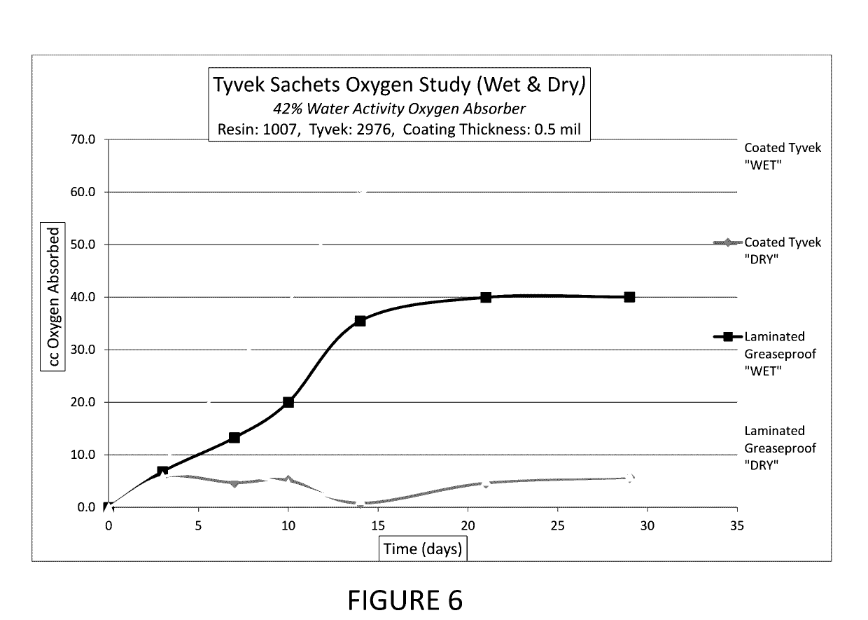

Additional tests were performed comparing the 0.5 mil coating of low-density polyethylene sachets and the perforated laminated sachets using an oxygen absorbing composition with a water activity of 42%. The testing procedure was the same as with the previous samples, with samples exposed to both wet and dry environments. The results, illustrated graphically in FIG. 6, show that the coated sachets performed far better than the other sachet types in a wet environment. However, when in a dry environment, both the coated film and laminated films performed almost exactly the same. While it appears that the coated spun-bonded polyolefin with this formulation may not enhance performance, it does provide the same performance as the more complex laminated films currently in use.

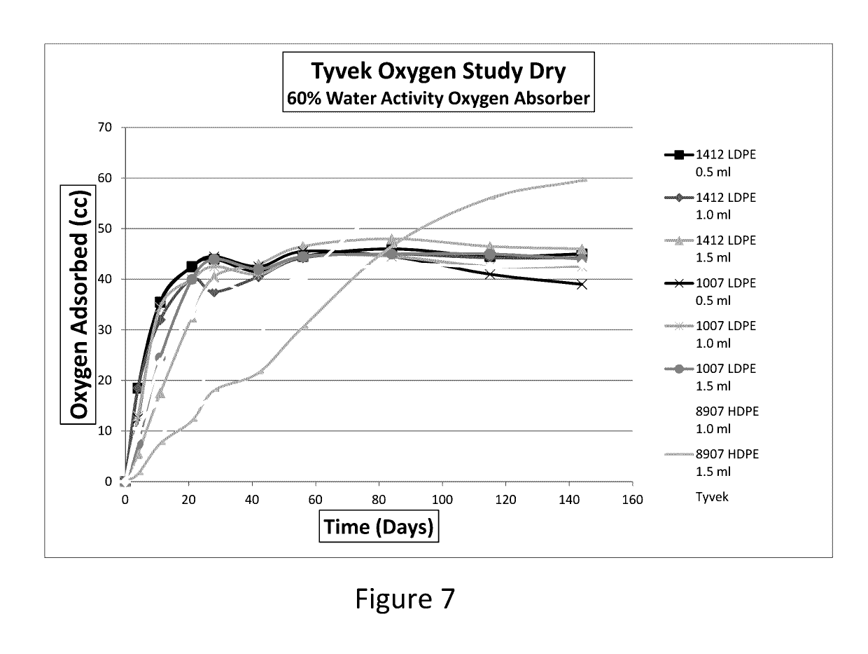

The high-density polyethylene was tested, alongside the low-density polyethylene, plain Tyvek, and laminated greaseproof sachets with the 60% water activity formulation. As the results show in FIG. 7, the high-density polyethylene absorbed slower than the low density polyethylene, laminated greaseproof, and Tyvek. However, its total capacity was far greater than the rest of the samples. This is likely because the high-density polyethylene is a far greater moisture barrier, allowing for more moisture in the sachet to partake in the oxygen absorption reactions.

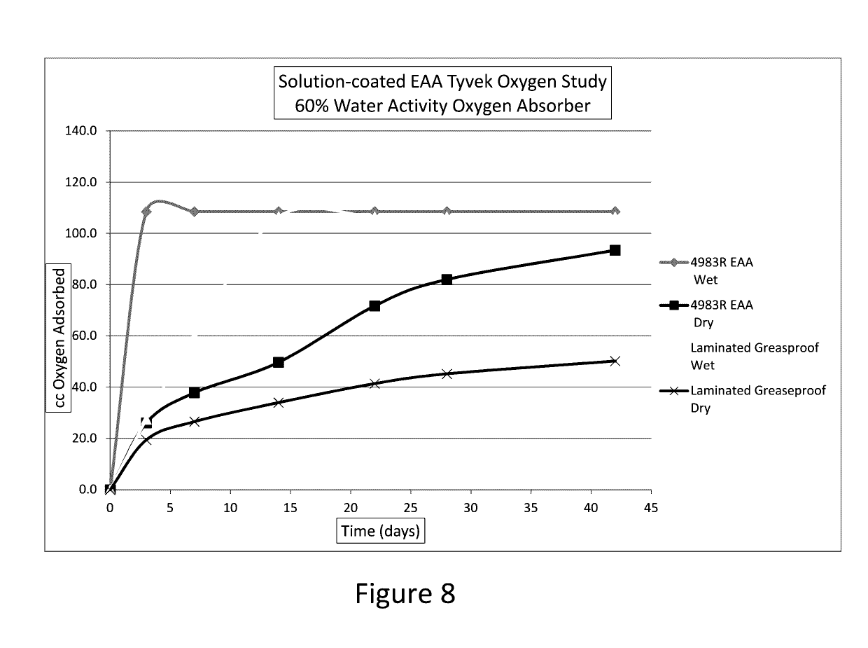

Additional testing was done with the solution coated ethylene acrylic acid. Samples were made in accordance to above, with a 60% water activity oxygen absorbing composition. The samples were placed in wet and dry environments, as described above, with corresponding samples of the greaseproof laminate film. The test results, as illustrated in FIG. 8, show that the wet ethylene acrylic acid samples reach their capacity faster than their laminated greaseproof counterparts. The dry samples show that the ethylene acrylic acid tends to absorb faster, and appears to be reaching its ultimate capacity faster than the laminated greaseproof fill, which appears to be reaching its capacity, which is lower than the dry ethylene acylic acid, likely because the ethylene acrylic acid is allowing for more of the oxygen absorbers moisture to be obtained.

As should be appreciated, according to embodiments of this disclosure a porous film with a non-porous coating is provided. By melt extruding the coating over substantially the entire surface of the base layer, the coating fills the pores at the surface to which the coating is applied, thereby rendering the final product substantially non-porous. Unlike conventional sachets, sachets formed with this coated film will not allow migration of particles of the sorbent contained within the sachet outside of the sachet. Accordingly, the sorbent cannot contaminate or otherwise interfere with the product the sachet is designed to protect. Moreover, by selecting the thickness and/or the type of material used for the coating, the oxygen water vapor permeabilities of the composite film are tunable, such as for different applications. Additionally, the so coated material can be sealed to itself using the same dimensional or similar techniques and is able to provide at least the same adhesive bonding strength as the uncoated materials.

While this invention has been described in conjunction with certain presently preferred embodiments thereof, those skilled in the art will recognize that many modifications and changes may be made without departing from the true spirit and scope of the invention which accordingly is intended to be defined solely by the appended claims.

1. An oxygen absorber comprising:
a container comprising a coated flexible film that includes a porous, spun-bonded high density polyolefin base layer and a continuous, permeable low-density polyethylene extrusion coated layer on the base layer, the container including at least one seal formed between first and second opposing edges of the flexible film at which seal the low-density polyethylene coating of a first one of the opposing edges is sealed to the spun-bonded high density polyolefin base layer of the second one of the opposing edge; and
an oxygen absorbing composition disposed in the container.

2. The oxygen absorber of claim 1 where the low-density polyethylene film has a thickness between about 0.25 mil and about 1.5 mil.

3. The oxygen absorber of claim 1 where the oxygen absorber comprises a powder.

4. The oxygen absorber of claim 1 where the oxygen absorber comprises a tablet.

5. An oxygen absorber comprising
a coated flexible film that includes a spun-bonded high density polyolefin base layer and a permeable, non-porous coating layer on the base layer such that the coated flexible film is non-porous;
at least one seal formed between first and second opposing edges of the flexible film; and
an oxygen absorber encapsulated by the flexible film

6. The oxygen absorber of claim 5 where the coating comprises a polymer.

7. The oxygen absorber of claim 6 where the polymer is low-density polyethylene.

8. The oxygen absorber of claim 5 where the coating faces the interior of the sachet.

9. The oxygen absorber of claim 5 where the coating has a thickness between 0.5 mil and 1.5 mil.

10. The oxygen absorber of claim 5 where the low-density polyethylene has a melt index between 4 and 16.

11. The oxygen absorber of claim 5 where the coating of a first opposing edge is sealed to the coating of the second opposing edge.

12. The oxygen absorber of claim 6 where the coating of the first opposing edge is sealed to the spun-bonded high-density polyolefin of the second opposing edge.

13. A method of making an oxygen absorber comprising:
activating a surface of a spun-bonded polyolefin;
coating the activated surface of the spun bonded polyolefin with melted low density polyethylene passed through a die;
sealing a first opposing edge of the coated spun-bonded polyolefin to a second opposing edge, and leaving an opening;
inserting an oxygen absorbing composition into the opening; and
sealing the sachet.

14. The method of claim 13 where the activating the surface of the spun bonded polyolefin comprises activating a rough side of the spun bonded polyolefin.

15. The method of claim 13 where the sachet is formed by having the coating on the interior of the sachet.

16. The method of claim 13 where the sealing comprises ultrasonic welding, impulse welding, or a combination thereof.

17. The method of claim 13 where the first seal is formed by sealing the coating of the first opposing edge to the spun-bonded high-density polyolefin of the second opposing edge.

18. The method of claim 13 where the first seal is formed by sealing the coating of the first opposing edge to the coating of the second opposing edge.

19. The method of claim 13, wherein the activating the surface comprises activating at an energy of about 2.6 kilowatts over about 60 inches.

20. The method of claim 13, wherein the low density polyethylene has a melt index of 7, and further comprising melting the low density polyethylene at a temperature of about 568 F.

21.-23. (canceled)
